(19) United States
(12) Patent Application Publication
(10) Pub. No.: US 2009/0178551 A1
(43) Pub. Date: Jul. 16, 2009

(54) SERVO SYSTEM USING FEEDBACK

(75) Inventors: Gary Garcia, Geneva, NY (US); Jeff Tyler, Newark, NY (US)

Correspondence Address: BROWN & MICHAELS, PC;400 M & T BANK BUILDING, 118 NORTH TIOGA ST, ITHACA, NY, 14850, US

(73) Assignee: G. W. Lisk Company, Inc., Clifton Springs, NY (US)

(21) Appl. No.: 12/355,391

(22) Filed: Jan. 16, 2009

Related U.S. Application Data
(60) Provisional application No. 61/021,482, filed on Jan. 16, 2008.

(51) Int. Cl. F01L 25/08; F15B 13/16; F16K 31/12

(52) U.S. Cl. 91/361; 251/30.01; 123/188.1

(57) ABSTRACT

A servo control system comprising a hydraulic actuator, a position sensor and a hydraulic control valve. The hydraulic actuator is coupled to a gas controlled valve. The position sensor measures the position of the hydraulic actuator and sends the position of the actuator as an input to an engine control unit (ECU). The hydraulic control valve is coupled to a proportional solenoid coupled to the ECU. When the ECU senses the position of the hydraulic actuator and in response to a control input, the ECU commands the position of the hydraulic control valve by controlling the force of the proportional solenoid and the hydraulic fluid sent to the hydraulic actuator, actuating the hydraulic actuator to move to a desired position and actuate the gas controlled valve.

### REFERENCE TO RELATED APPLICATIONS

This application claims one or more inventions which were disclosed in Provisional Application No. 61/021,482 filed Jan. 16, 2008, entitled “SERVO SYSTEM USING FEEDBACK”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of servo systems. More particularly, the invention pertains to actuated servo systems using feedback.

2. Description of Related Art

In U.S. Pat. No. 6,883,320, a servomechanism for a valve controlling engine intake uses a proportional solenoid operating a hydraulic valve to power a hydraulic actuator, setting the position of the control valve. An engine sensor and electric controller provide input to the proportional solenoid. Feedback from the position of the control valve is applied to the hydraulic valve by a cam and a spring applying a force in opposition to the proportional solenoid. The mechanical feedback in US'320 applies a direct force on the valve via the spring.

### SUMMARY OF THE INVENTION

A servo control system comprising a hydraulic actuator, a position sensor and a hydraulic control valve. The hydraulic actuator is coupled to a gas controlled valve. The position sensor measures the position of the hydraulic actuator and sends the position of the actuator as an input to an engine control unit (ECU). The hydraulic control valve is coupled to a proportional solenoid coupled to the ECU. When the ECU senses the position of the hydraulic actuator and in response to a control input, the ECU commands the position of the hydraulic control valve by controlling the force of the proportional solenoid and the hydraulic fluid sent to the hydraulic actuator, actuating the hydraulic actuator to move to a desired position and actuate the gas controlled valve.

In an alternate embodiment, the hydraulic actuator may be coupled to a rack and a valve may be actuated through a pinion and a rotary shaft. The valve may be a butterfly or flapper valve.

### BRIEF DESCRIPTION OF THE DRAWING

FIG. 1 shows a schematic of a hydraulically actuated servo system using electrical feedback and rotary output.

FIG. 2 shows a more detailed schematic of the control valve of FIGS. 1 and 3.

FIG. 3 shows a schematic of a hydraulically actuated servo system for a poppet EGR valve.

FIG. 4a shows a schematic of a control system in which a hydraulic actuator controls a gas operated poppet control valve with a hydraulic control valve in a stationary position. FIG. 4b shows a schematic of a control system in which a hydraulic actuator controls a gas operated poppet control valve with a hydraulic control valve moving towards a first position. FIG. 4c shows a schematic of a control system in which a hydraulic actuator controls a gas operated poppet control valve with a hydraulic control valve moving towards a second position.

FIG. 5a shows a schematic of a control system in which a hydraulic actuator controls a rotary device with a hydraulic control valve in a closed position. FIG. 5b shows a schematic of a control system in which a hydraulic actuator controls a rotary device with a hydraulic control valve in a mid position.

### DETAILED DESCRIPTION OF THE INVENTION

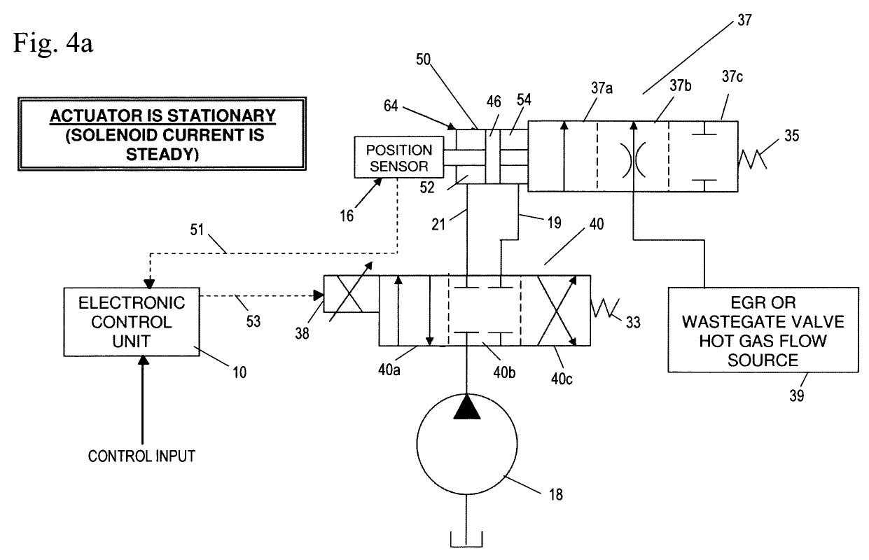

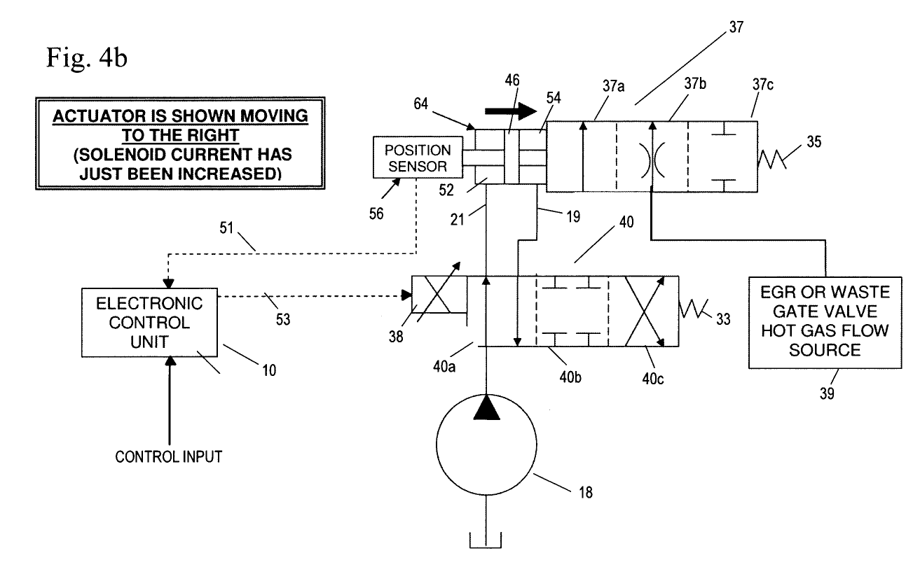

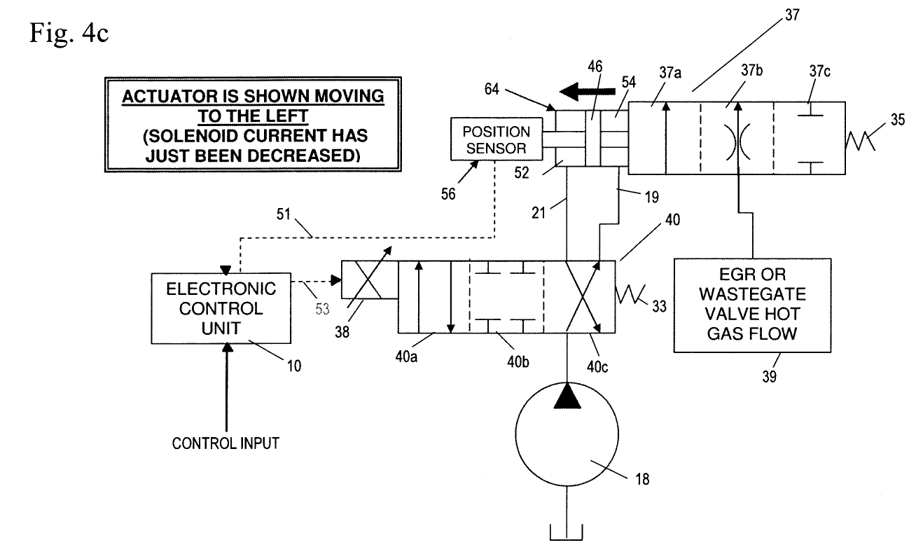

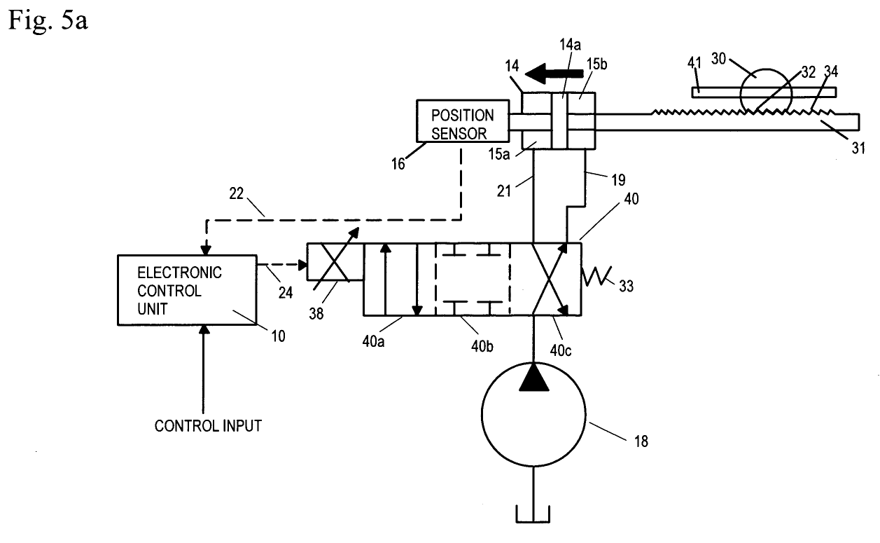

FIGS. 4a through 4c show schematics of a proportional position feedback hydraulic servo system. FIG. 4a shows a schematic of a control system in which a hydraulic actuator controls a gas operated poppet control valve with a hydraulic control valve in a stationary position. FIG. 4b shows a schematic of a control system in which a hydraulic actuator controls a gas operated poppet control valve with a hydraulic control valve moving towards a first position. FIG. 4c shows a schematic of a control system in which a hydraulic actuator controls a gas operated poppet control valve with a hydraulic control valve moving towards a second position.

Referring to FIGS. 4a through 4c a double acting hydraulic actuator in fluid communication with a hydraulic control valve 28. The hydraulic control valve 28 includes a spool 40 with a plurality of lands that is actuated by a proportional solenoid 38 on one side and a spring 33 on the opposite side. The proportional solenoid 38 is in communication with an engine control unit (ECU) 10. The double acting hydraulic actuator 64 operates a gas operated poppet valve 37 such as a poppet wastegate valve or a poppet EGR valve. The gas operated poppet valve 37 shown in FIGS. 4a-4c is shown by a three position valve in which hot gas flow from a source is blocked 37c, restricted 37b, or allowed 37a to flow to or from an exhaust gas component. The position of a piston 46 of the double acting hydraulic actuator 64 is monitored by a position sensor 56. The position sensor 56 is in communication with the engine control unit (ECU) 10. The position sensor 56 produces a feedback signal 51 in proportion to the hydraulic actuator position which gets sent to the ECU 10. The ECU 10 uses the feedback signal 51, other engine parameters, and a control input to generate a signal 53 that is sent to the proportional solenoid 38 to change the current, changing the position of the spool 40, the hydraulic fluid sent to hydraulic actuator 64, and the position of the gas operated poppet valve 37.

Referring to FIG. 4a, the position sensor 56 monitors the position of the piston 46 of the double acting hydraulic actuator 64 and sends a signal 22 to the ECU 10. The ECU 10 uses the feedback signal 51 from the position sensor 56, other engine parameters, and a control input and sends a signal 53 to the proportional solenoid 38. In this case, the signal 53 sent from the ECU 10 did not alter the current being supplied to the proportional solenoid 38. With the current remaining in a steady state, the spool 40 is not moved and remains in position, which happens to be in a middle position 40b as shown. In this position, the lands of the spool 40 block the flow of fluid to or from the chambers 52, 54 defined between the piston 46 and the housing 50 of the double acting hydraulic actuator 64. Since fluid is prevented from flowing in or out of the chambers 52, 54 formed between the piston 46 and the housing 50 of the double acting hydraulic actuator 64, the gas operated poppet valve 37 also remains in position, which happens to be a middle position 37b, in which hot gas flow from a source is restricted from flowing to or from an exhaust gas component. If the force of the spring 33 on the spool 40 increases or decreases and the force on the spool 40 from the proportional solenoid 38 remains the same, the spool 40 will move accordingly. If the force of the proportional solenoid 38 on the spool 40 increases or decreases and the force on the spool 40 from the spring 33 remains the same, the spool will move accordingly.

Referring to FIG. 4b, the position sensor 56 monitors the position of the piston 46 of the double acting hydraulic actuator 64 and sends a signal 51 to the ECU 10. The ECU 10 uses the feedback signal 51 from the position sensor 56, other engine parameters and a control input and sends a signal 53 to the proportional solenoid 38. The signal 53 from the ECU 10 increases the current to the proportional solenoid 38, increasing the force on the one end of the spool 40 to be greater than the spring 33 force on the opposite end of the spool 40, moving the spool 40 towards the spring 33 (towards the right in the figure) towards a first position 40a until the spring force equals the force from the proportional solenoid 38. Once the force of the spring equals the force of the proportional solenoid 38, the spool 40 moves to an equilibrium position. If the force of the spring 33 on the spool 40 increases or decreases and the force on the spool 40 from the proportional solenoid 38 remains the same, the spool 40 will move accordingly. If the force of the proportional solenoid 38 on the spool 40 increases or decreases and the force on the spool 40 from the spring 33 remains the same, the spool will move accordingly. With the spool 40 moving towards the first position 40a, fluid from a first chamber 52 formed between the piston 46 and the housing 50 of the double acting hydraulic actuator 64 receives fluid from a source 18 and the opposite second chamber 54 is exhausts fluid through the spool 40 to sump (not shown). By filling one chamber 52 and exhausting the other chamber 54 of the double acting hydraulic actuator 64, the piston 46 moves towards the spring 35 (towards the right in the figure), against the force of the spring 35 on the gas operated poppet valve 37, moving the poppet valve towards a first position 37a in which hot gas flow is allowed from the source to or from an exhaust gas component until the force of the spring 35 on the gas operated valve 37 equals the force of the fluid acting on the piston 46 of the double acting hydraulic actuator 64. When the force of the spring 35 equals the force of the fluid acting on the piston 46 of the double acting hydraulic actuator 64, the gas operated poppet valve 37 moves to an equilibrium position. If the force of the spring 35 on the gas operated poppet valve 37 increases or decreases and the force on the gas operated poppet valve 37 from the hydraulic actuator 64 remains the same, the gas operated poppet valve 37 will move accordingly. If the force of the hydraulic actuator 64 on the gas operated poppet valve 37 increases or decreases and the force on the gas operated poppet valve 37 from the spring 35 remains the same, the gas operated poppet valve 37 will move accordingly.

Referring to FIG. 4c, the position sensor 56 monitors the position of the piston 46 of the double acting hydraulic actuator 64 and sends a signal 51 to the ECU 10. The ECU 10 uses the feedback signal 22 from the position sensor 56, other engine parameters, and a control input and sends a signal 53 to the proportional solenoid 38. The signal 53 from the ECU 10 has decreases the current to the proportional solenoid 38, decreasing the force on the one end of the spool 40 to be less than the spring 33 force on the opposite end of the spool 40, moving the spool 40 towards the proportional solenoid 38 (towards the left in the figure) towards a second position 40c until the spring 33 force equals the force from the proportional solenoid 38. Once the force of the spring 33 equals the force of the proportional solenoid 38, the spool 40 moves to an equilibrium position. If the force of the spring 33 on the spool 40 increases or decreases and the force on the spool 40 from the proportional solenoid 38 remains the same, the spool 40 will move accordingly. If the force of the proportional solenoid 38 on the spool 40 increases or decreases and the force on the spool 40 from the spring 33 remains the same, the spool will move accordingly. With the spool 40 moving towards the second position 40c, fluid from a second chamber 54 formed between the piston 46 and the housing 50 of the double acting hydraulic actuator 64 is receives fluid from a source 18 and the opposite first chamber 52 is exhausts fluid through the spool 40 to sump (not shown). By filling one chamber 54 and exhausting the other chamber 52 of the double acting hydraulic actuator 64, the piston 46 moves towards the left in the figure, with the force of the spring 35 on the gas operated poppet valve 37, moving the gas operated poppet valve towards a third position 37c in which hot gas flow is blocked from a source to or from an exhaust gas component until the force of the spring 35 on the gas operated valve 37 equals the force of the fluid acting on the piston 46 of the double acting hydraulic actuator 64. When the force of the spring 25 equals the force of the fluid acting on the piston 46 of the double acting hydraulic actuator 64, the gas operated poppet valve 37 moves to an equilibrium position. If the force of the spring 35 on the gas operated poppet valve 37 increases or decreases and the force on the gas operated poppet valve 37 from the hydraulic actuator 64 remains the same, the gas operated poppet valve 37 will move accordingly. If the force of the hydraulic actuator 64 on the gas operated poppet valve 37 increases or decreases and the force on the gas operated poppet valve 37 from the spring 35 remains the same, the gas operated poppet valve 37 will move accordingly.

After the gas operated valve 37 is moved, the position sensor 56 monitors the position of the piston 46 of the double acting hydraulic cylinder and compares the position of the piston 46 to the control input sent to the ECU 10.

It should be noted that the gas operated valve 37 is shown in the middle position in FIGS. 4a-4c, and the arrow above the hydraulic actuator 64 indicates the direction in which the gas operated valve 37 is going to move.

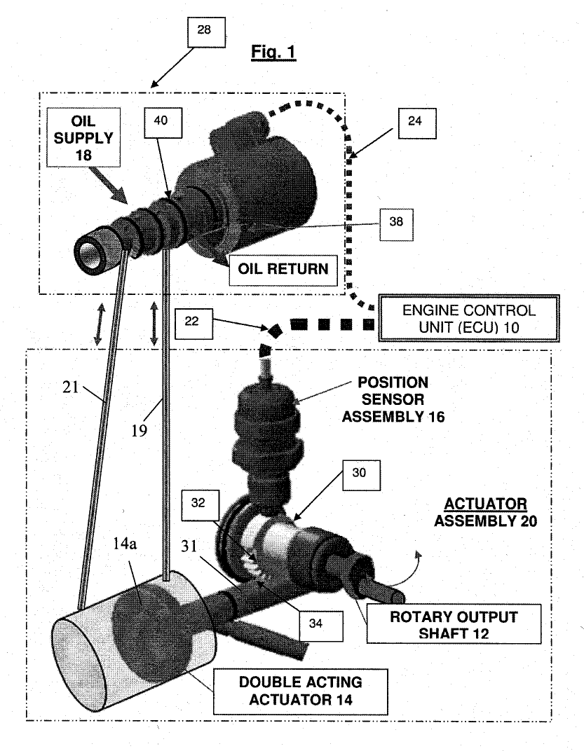

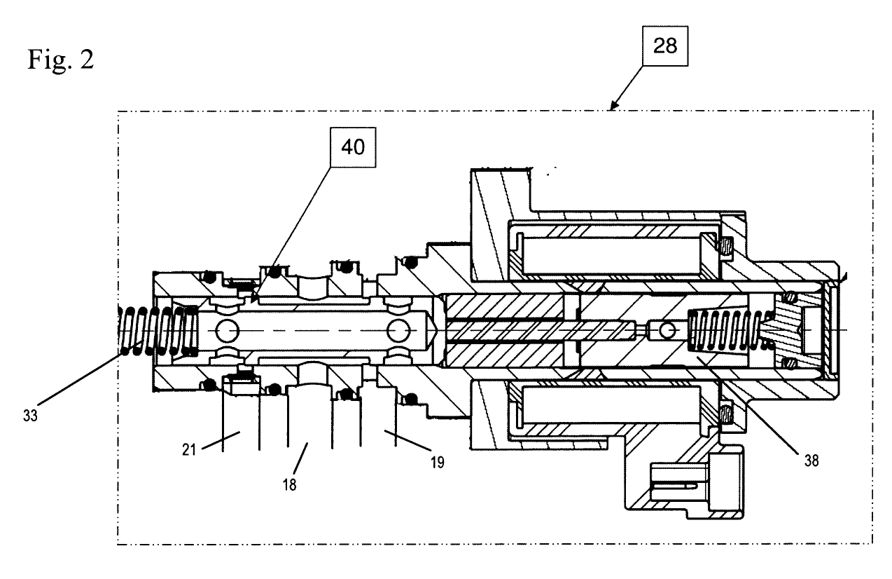

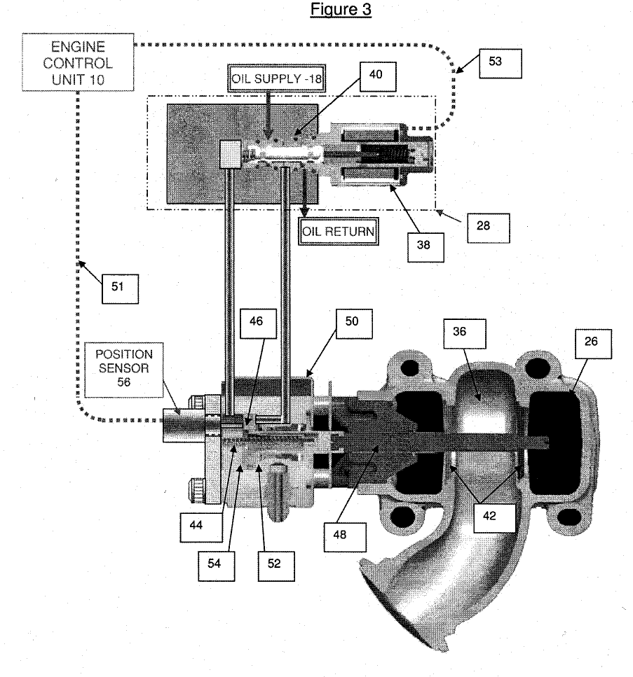

FIG. 3 shows an example of the servo system shown in FIGS. 4a-4c in which the double acting hydraulic actuator 64 is operating a gas operated poppet valve 37, such as an EGR valve sealed by poppet valves 42. FIG. 2 shows a more detailed schematic of the hydraulic control valve 40 used in FIGS. 1 and 3. The gas operated poppet valve 37 in this example would be the poppet valve 42.

The intake and the exhaust chambers 26, 36 of an EGR valve are sealed by poppet valves 42. The position of the poppet valves 42 are controlled by a spring 44 and hydraulically biased piston 46 attached to the poppet valves 42 via a rod 48. The spring 44 and the hydraulically biased piston 46 is received within a housing 50 and forms fluid chambers 52, 54 on either side of the piston 46 within the housing 50. A position sensor 56 is present on the piston housing 50 and electrically sends signals regarding the piston 46 position to an ECU 10. The ECU 10 then sends a signal 53 to a proportional solenoid 38 of a control valve 28. The proportional solenoid 38 adjusts the spool 40 position.

When the spool 40 is in the position shown in FIG. 4b, supply oil 18 flows as directed by the spool 40 to a first chamber 52 formed between the piston 46 and the housing 50, and works in conjunction with the force of the spring 44, opening the poppet valves 42 between the exhaust and the intake chambers 36, 26. The position sensor 56 electronically provides feedback of piston 46 position to the ECU 10 that sends an appropriate signal to the proportional solenoid 38.

The proportional solenoid 38 shown is a variable force solenoid but a voice coil actuator or similar linear force motor may also be used. The control valve 28 may be located remotely as shown in FIG. 3 or may be packaged within the EGR housing 50 in any orientation.

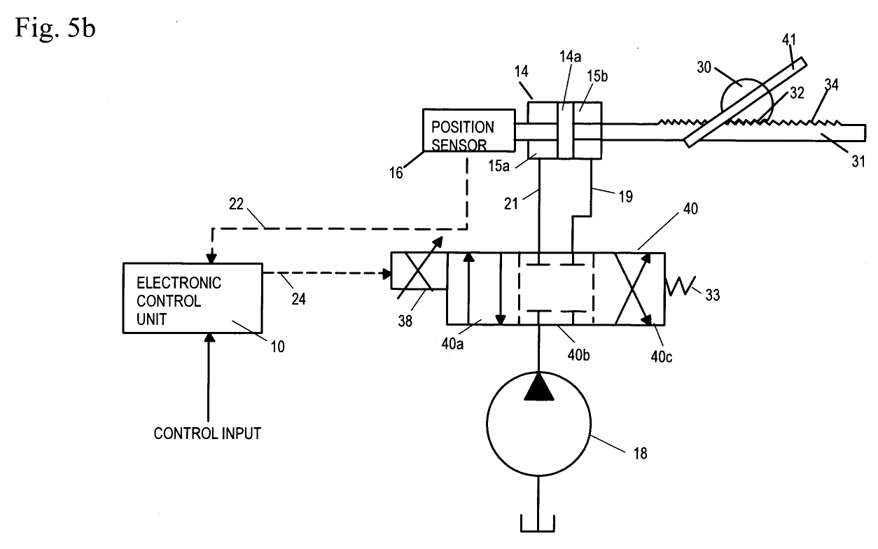

FIG. 5a shows a schematic of a control system in which a hydraulic actuator controls a rotary device with a hydraulic control valve in a closed position. FIG. 5b shows a schematic of a control system in which a hydraulic actuator controls a rotary device with a hydraulic control valve in a mid position.

Referring to FIGS. 5a and 5b, the double acting hydraulic actuator 14 is connected to a rotary output shaft 12 that operates butterfly valve or a flapper valve 41 through a rack 34 and pinion 32 and is in fluid communication with a hydraulic control valve 28. The hydraulic control valve 28 includes a spool 40 with a plurality of lands that is actuated by a proportional solenoid 38 on one side and a spring 33 on the opposite side. The proportional solenoid 38 is in communication with an engine control unit (ECU) 10. The double acting hydraulic actuator 14 operates a flapper valve or butterfly valve 41 through a rack and pinion. The butterfly valve or flapper valve is indicated by reference number 41 shown in FIGS. 5a and 5b. The flapper and butterfly valve 41 have a closed position and an open position. The amount the flapper or butterfly valve 41 is open will vary and is not limited to the position shown in FIG. 5b. The position of a piston 14a of the double acting hydraulic actuator 14 is monitored by a position sensor 16. The position sensor 16 is in communication with the engine control unit (ECU) 10. The position sensor 16 produces a feedback signal 22 in proportion to the actuator position which gets sent to the ECU 10. The ECU 10 uses the feedback signal 22, other engine parameters, and a control input to generate a signal 24 that is sent to the proportional solenoid 38 to change the current, changing the position of the spool 40, the hydraulic fluid sent to the hydraulic actuator 14 and the position of the butterfly or flapper valve 41.

Referring to FIG. 5a, the position sensor 16 monitors the position of the piston 14a of the double acting hydraulic actuator 14 and a sends a signal 22 to the ECU 10. The ECU 10 uses the feedback signal 22 from the position sensor 16, other engine parameters, and a control input and sends a signal 24 to the proportional solenoid 38. The signal 24 from the ECU 10 decreases the current to the proportional solenoid 38, decreasing the force on the one end of the spool 40 to be less than the spring 33 force on the opposite end of the spool 40, moving the spool 40 towards the proportional solenoid 38 (towards the left in the figure) towards a second position 40c until the spring force equals the force from the proportional solenoid 38. Once the force of the spring 33 equals the force of the proportional solenoid 38, the spool 40 moves to an equilibrium position. If the force of the spring 33 on the spool 40 increases or decreases and the force on the spool 40 from the proportional solenoid 38 remains the same, the spool 40 will move accordingly. If the force of the proportional solenoid 38 on the spool 40 increases or decreases and the force on the spool 40 from the spring 33 remains the same, the spool will move accordingly. With the spool 40 in the second position 40c, fluid from a second chamber 15b formed between the piston 14a and the housing 17 of the double acting hydraulic actuator 14 receives fluid from a source 18 and the opposite first chamber 15a is exhausts fluid through the spool 40 to sump (not shown). By filling one chamber 15b and exhausting the other chamber 15a of the double acting hydraulic actuator 14, the rack 34 on the second shaft 31 and coupled to the piston 14a of the double acting hydraulic actuator is moved, and the pinion 32 meshed with the rack 34 and mounted to the rotary shaft 12 rotates, rotating the butterfly valve 41 mounted to the rotary shaft 31 to a closed position in which fluid is prevented from flowing to or form a source to an exhaust gas component. Once the spool 40 moves to an equilibrium position, the rack 34 on the second shaft 31 moves, rotating the pinion 32 and thus the butterfly valve 41 to an equivalent equilibrium position.

Referring to FIG. 5b, the position sensor 16 monitors the position of the piston 14a of the double acting hydraulic actuator 14 and a sends a signal 22 to the ECU 10. The ECU 10 uses the feedback signal 22 from the position sensor 16, other engine parameters, and a control input and sends a signal 24 to the proportional solenoid 38. In this case, the signal 24 sent from the ECU 10 did not alter the current being supplied to the proportional solenoid 38. With the current remaining in a steady state, the spool 40 is not moved and remains in a middle position in which 40b as shown. In this position, the lands of the spool 40 blocks the flow of fluid to or from the chambers 15a, 15b defined between the piston 14a and the housing 17 of the double acting hydraulic actuator 14. Since fluid is prevented from flowing in or out of the chambers 15a, 15b formed between the piston 14a and the housing 17 of the double acting hydraulic actuator 14, the rack 34 and pinion 32 are not rotated by the double acting hydraulic actuator 14 and the butterfly or flapper valve remains in a middle position in which fluid may flow from a source to an exhaust gas component.

After the butterfly valve or flapper valve 41 is moved, the position sensor 16 monitors the position of the piston 14a of the double acting hydraulic cylinder and compare the position of the piston 14a to the control input sent to the ECU 10.

FIGS. 1 and 2 show an example of the control system shown in FIGS. 5a-5b, with the double acting hydraulic actuator being coupled to a rotary device. Referring to FIG. 1, a cam 30 and pinion 32 are mounted on a rotary output shaft 12. The pinion 32 meshes with a rack 34 on a second shaft 31. The cam 30 on the rotary output shaft 12 contacts a position sensor 16. The position sensor 16 is in communication with an engine control unit (ECU) 10. At the end of the rack 34, a piston 14a of a double acting actuator 14 is attached. The double acting actuator 14 is in fluid communication with a hydraulic control valve 28.The hydraulic control valve 28 includes a proportional solenoid 38 in communication with the engine control unit 10 and in contact with a spool valve 40. The proportional solenoid 38 of the hydraulic control valve 28 adjusts the position of the spool 40, determining the flow of fluid to the double acting actuator 14.

Based on the movement of the cam 30, the position sensor 16 sends a feedback signal 22 to an engine control unit (ECU) 10. The ECU 10 then sends a signal 24 based on the feedback signal 22, other engine parameters, and a control input to the proportional solenoid 38 of a hydraulic control valve 28. The signal 24 may adjust the current supplied to the proportional solenoid 38 of a hydraulic control valve 28. Depending on the adjustment to the current of the proportional solenoid 38 of the hydraulic control valve 28, the spool 40 is moved as shown in FIGS. 5a-5b. If the current is increased or decreased, the spool 40 is moved by the solenoid 38 and the flow of fluid to the double acting hydraulic actuator 14 is adjusted. By adjusting the flow to the double acting hydraulic actuator 14, the piston 14a of the double acting hydraulic actuator 14 is moved and thus the rack 34 in which the piston 14a is attached is also moved. By moving the rack 34 on the second shaft 31, the pinion 32 and cam 30 on the rotary output shaft 12 are also moved. The rotation of the rotary output shaft rotates the position of the butterfly or flapper valve. The position of the cam 30 is measured by the position sensor 16.

The rotary output shaft 12 may be connected to a turbocharger wastegate, an EGR wastegate, a bypass valve, flapper valve, butterfly valve, or other modulated devices. The control valve 28 may be located remotely as shown in FIG. 1 or may be packaged within the actor assembly 20 housing.

The proportional solenoid 38 may be a variable force solenoid, a voice coil actuator or similar linear motor.

Alternatively, the position sensor 16 may be mounted directly to the flapper or butterfly valve 41.

Other types of hydraulic actuators may also be used other the than the linear actuator shown.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A servo control system comprising:
a hydraulic actuator coupled to a gas controlled valve;
a position sensor measuring the position of the hydraulic actuator and sending the position of the hydraulic actuator as an input to the engine control unit;
a hydraulic control valve coupled to a proportional solenoid coupled to the engine control unit;
wherein when the engine control unit senses the position of the hydraulic actuator and in response to a control input commands the position of the hydraulic control valve by controlling the force of the proportional solenoid and the hydraulic fluid sent to the hydraulic actuator, actuating the hydraulic actuator to move to a desired position, the hydraulic actuator actuating the gas controlled valve.

2. The servo system of claim 1, wherein the gas controlled valve is a poppet EGR valve.

3. The servo system of claim 1, wherein the gas control valve is a poppet wastegate valve.

4. The servo system of claim 1, wherein the proportional solenoid is a variable force solenoid, a voice coil or a linear force motor.

5. A servo system comprising:
a hydraulic actuator coupled to a rack on a second shaft;
a pinion mounted to a rotary shaft coupled to a valve and meshing with the rack on the second shaft;
a position sensor measuring the position of the hydraulic actuator and sending the position of the hydraulic actuator as an input to the engine control unit;
a hydraulic control valve coupled to a proportional solenoid coupled to the engine control unit;
wherein when the engine control unit senses the position of the hydraulic actuator and in response to a control input commands the position of the hydraulic control valve by controlling the force of the proportional solenoid and the hydraulic fluid sent to the hydraulic actuator, actuating the hydraulic actuator to move to a desired position, actuating the valve.

6. The servo system of claim 5, wherein the valve is a flapper valve.

7. The servo system of claim 5, wherein the valve is butterfly valve.

8. The servo system of claim 5, wherein the proportional solenoid is a variable force solenoid, a voice coil or a linear force motor.

9. A method of controlling a servo system comprising:
a) sensing a position of a hydraulic actuator;
b) sending the position of the hydraulic actuator to an engine control unit;
c) sending a signal from the engine control unit to a hydraulic control valve comprising a proportional solenoid, based on the position of the hydraulic actuator and a control input, wherein the signal commands a desired position of the hydraulic control valve by controlling the force of the proportional solenoid and hydraulic fluid sent to the hydraulic actuator;
d) actuating the hydraulic actuator to move to the desired position by moving the hydraulic control valve and fluid flowing to the hydraulic actuator; wherein actuating the hydraulic actuator actuates a gas controlled valve

10. The method of claim 9, wherein the gas controlled valve is a poppet EGR valve.

11. The method of claim 9, wherein the gas control valve is a poppet wastegate valve.
